(19) United States
(12) Patent Application Publication
(10) Pub. No.: US 2022/0148064 A1
(43) Pub. Date: May 12, 2022

(54) PRODUCT CHARACTERISTIC SCORE ESTIMATION DEVICE, METHOD, AND PROGRAM

(71) Applicant: NEC Corporation, Minato-ku, Tokyo (JP)

(72) Inventors: Koji ICHIKAWA, Tokyo (JP); Hiroshi TAMANO, Tokyo (JP)

(73) Assignee: NEC Corporation, Minato-ku, Tokyo (JP)

(21) Appl. No.: 17/430,385

(22) PCT Filed: Feb. 18, 2019
(86) PCT No.: PCT/JP2019/005745

§ 371 Date: Aug. 12, 2021

(51) Int. Cl. G06Q 30/06; G06F 16/9035; G06Q 30/02

(52) U.S. Cl. CPC G06Q 30/0631; G06Q 30/0201; G06Q 30/0282; G06F 16/9035

(57) ABSTRACT

An input unit 81 inputs pieces of training data indicating products as targets of a behavior in accordance with preferences of users. An estimation unit 82 estimates a preference distribution indicating the preferences of each user corresponding to product attributes and a preference degree of the user between the products for the product attributes indicating characteristics of the products based on the product attributes and the training data. The estimation unit 82 estimates the preference distribution and the preference degree between the products by using the training data when a behavior probability for the product based on the training data is calculated by a product of a probability of the preference of the user selected based on the preference distribution and a probability of selecting a specific product based on the preference of the user selected with the probability and the preference degree between the products.

### TECHNICAL FIELD

The present invention relates to a product characteristic score estimation device, a product characteristic score estimation method, and a product characteristic score estimation program for estimating a preference degree between products of a user for product attributes.

### BACKGROUND ART

Product explanatory sentences described by manufacturers are given to many products. The explanatory sentence includes items set by the manufacturer as appeal points of the product.

However, the appeal points set by the manufacturer are not necessarily accepted by the user. For example, it is assumed that there is a plurality of products (for example, “odoriferous ***”) that are appealed for the scent. In this case, the quality of efficacy is considered to be different for each product even in the case of the same “odoriferous”.

For example, a product explanatory sentence of a certain beer often describes a plurality of appeal points such as “body”, “strength of aroma”, “depth”, “flavor”, “foam”, “color”, “taste”, and “drinking going down one's throat”. However, it is difficult to determine which appeal points are accepted and how much these appeal points contribute to sales as compared with other products. This is because, for example, a user who selects a product based on “flavor” strongly prefers a certain beer, but when a product is selected based on “body”, there is a possibility that a beer appealing to “body” of other companies is selected.

PTL 1 describes an information processing device that presents information on a product or the like useful for sales promotion when information on a product or a service is presented. The information processing device described in PTL 1 calculates a comprehensive evaluation value that is a comprehensive evaluation for each product based on knowledge source information including subjective information of a user for an attribute, an importance level, and a certainty level for the subjective information.

PTL 2 describes a method for ranking products. In the method described in PTL 2, a plurality of pieces of product information is decided as a result of responding to one or more query words, and the product information associated with the highest user demand value is displayed in order among a plurality of pieces of ranked product information.

PTL 3 describes an attribute information optimization device that optimizes attribute information of a customer and attribute information of a product to be used for selecting the product or the like to be recommended to the customer. The device described in PTL 3 sets a common attribute item for each customer and product to be recommended, and records a score indicating a degree of the attribute in a customer attribute master and a product attribute master for each customer and each product. When the customer purchases the product, for the common attribute item, the score indicating the degree of the attribute of the product is reflected in a score indicating a degree of an attribute of the customer who has purchased the product, and the score indicating the degree of the attribute of the customer who has purchased the product is also reflected in the score indicating the degree of the attribute of the product.

### CITATION LIST

### Patent Literature

PTL 1: Japanese Patent Laid-Open No. 2005-284421

PTL 2: Japanese National Publication of International Patent Application No. 2014-501013

PTL 3: Japanese Patent Laid-Open No. 2014-115951

### SUMMARY OF INVENTION

### Technical Problem

In the device described in PTL 1, there is a problem that it takes cost to create a questionnaire to be conducted to users, collect answers to the questionnaire, and evaluate reliability. It is difficult for the user to correctly set the score for the product as a target for the questionnaire. For example, a scene in which the user evaluates “moisture retaining property” when the user purchases a certain cosmetic product is assumed. In this scene, the user may not accurately score the same attribute of “moisture retaining property” as compared to similar products. As in the device described in PTL 1, there is a problem that a questionnaire about all appeal points (attributes) of all products is not realistic in many cases.

In the method described in PTL 2, a keyword search word is associated with an attribute, and a product within the attribute is rated by using popularity such as a click-through rate or page review as an index. However, when a purchase is made at an actual store, since information corresponding to a search word cannot be obtained, the method described in PTL 2 has a problem that it is not possible to determine which appeal point the user has made the purchase using as a determination criterion.

In the device described in PTL 3, since scores are reflected for all attributes at the time of update, scores for completely different attributes are also updated, and thus, there is a problem that interpretation becomes difficult. For example, even when updating is performed for a certain red wine, since a score of an attribute such as beer or white wine is updated, it may be difficult to interpret the update result.

In the case of the device described in PTL 3, there is also a problem that it is difficult to prepare an appropriate attribute and it is difficult to set a value for the attribute. For example, in PTL 3, attributes such as “male”, “young man”, “organized”, and “outdoor” are set for a certain customer, but it is difficult to prepare such attributes and it is difficult to set values for the prepared attributes.

As described above, when information is collected by the questionnaire or the like, the cost is high, and the reliability of the score is also difficult. In ranking the products according to popularity for each attribute by the search keyword, when there is no search keyword, it is difficult to determine which appeal point the user has purchased as a determination criterion in many cases. When the device described in PTL 3 is used, a score is added to an attribute that the product originally does not have, and thus, interpretation may become difficult. Thus, it is preferable that the preference degree (score) of the user can be set so as not to contradict the appeal point of each product with respect to the attribute of the product while suppressing the cost.

Accordingly, an object of the present invention is to provide a product characteristic score estimation device, a product characteristic score estimation method, and a product characteristic score estimation program capable of estimating a preference degree between products of a user for characteristics of the products.

### Solution to Problem

A product characteristic score estimation device according to the present invention includes an input unit that inputs pieces of training data indicating products as targets of a behavior in accordance with preferences of users, and an estimation unit that estimates a preference distribution indicating the preferences of each user corresponding to product attributes and a preference degree of the user between the products for the product attributes indicating characteristics of the products based on the product attributes and the training data. The estimation unit estimates the preference distribution and the preference degree between the products by using the training data when a behavior probability for the product based on the training data is calculated by a product of a probability of the preference of the user selected based on the preference distribution and a probability of selecting a specific product based on the preference of the user selected with the probability and the preference degree between the products.

A product characteristic score estimation method according to the present invention includes inputting pieces of training data indicating products as targets of a behavior in accordance with preferences of users, and estimating a preference distribution indicating preferences of each user corresponding to product attributes and a preference degree of the user between the products for the product attributes indicating characteristics of the products based on the product attributes and the training data. In the estimation, the preference distribution and the preference degree between the products are estimated by using the training data when a behavior probability for the product based on the training data is calculated by a product of a probability of the preference of the user selected based on the preference distribution and a probability of selecting a specific product based on the preference of the user selected with the probability and the preference degree between the products.

A product characteristic score estimation program according to the present invention causes a computer to execute input processing of inputting pieces of training data indicating products as targets of a behavior in accordance with preferences of users, and estimation processing of estimating a preference distribution indicating the preferences of each user corresponding to product attributes and a preference degree of the user between the products for the product attributes indicating characteristics of the products based on the product attributes and the training data. In the estimation processing, the preference distribution and the preference degree between the products are estimated by using the training data when a behavior probability for the product based on the training data is calculated by a product of a probability of the preference of the user selected based on the preference distribution and a probability of selecting a specific product based on the preference of the user selected with the probability and the preference degree between the products.

### Advantageous Effects of Invention

According to the present invention, it is possible to estimate the preference degree between the products of the user for the characteristics of the product.

### BRIEF DESCRIPTION OF DRAWINGS

FIG. 1 It depicts a block diagram illustrating a configuration example of a first exemplary embodiment of a product characteristic score estimation device according to the present invention.

FIG. 2 It depicts an explanatory diagram illustrating a relationship example between a preference and purchase of a user.

FIG. 3 It depicts an explanatory diagram illustrating an example of a preference degree between products for product attributes.

FIG. 4 It depicts an explanatory diagram illustrating an example of processing of estimating the preference degree from the product attributes of the product.

FIG. 5 It depicts an explanatory diagram illustrating an example of an output result.

FIG. 6 It depicts a flowchart illustrating an operation example of the product characteristic score estimation device according to the first exemplary embodiment.

FIG. 7 It depicts a block diagram illustrating a configuration example of a second exemplary embodiment of the product characteristic score estimation device according to the present invention.

FIG. 8 It depicts an explanatory diagram illustrating a relationship example between the preference and the purchase of the user and closeness of meaning between words.

FIG. 9 It depicts an explanatory diagram illustrating an example in which the product attributes and user preferences are aggregated.

FIG. 10 It depicts a flowchart illustrating an operation example of the product characteristic score estimation device according to the second exemplary embodiment.

FIG. 11 It depicts a block diagram illustrating a configuration example of a third exemplary embodiment of the product characteristic score estimation device according to the present invention.

FIG. 12 It depicts an explanatory diagram illustrating an example of conversion processing based on a relationship between the preference of the user and the product attribute.

FIG. 13 It depicts an explanatory diagram illustrating another relationship example between the preference and the purchase of the user and the closeness of meaning between the words.

FIG. 14 It depicts a flowchart illustrating an operation example of the product characteristic score estimation device according to the third exemplary embodiment.

FIG. 15 It depicts a block diagram illustrating an outline of the product characteristic score estimation device according to the present invention.

FIG. 16 It depicts a schematic block diagram illustrating a configuration of a computer according to at least one exemplary embodiment.

### DESCRIPTION OF EMBODIMENTS

Hereinafter, exemplary embodiments of the present invention will be described with reference to the drawings.

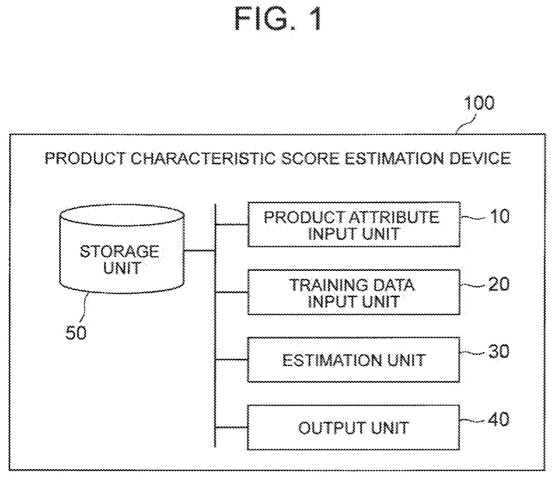

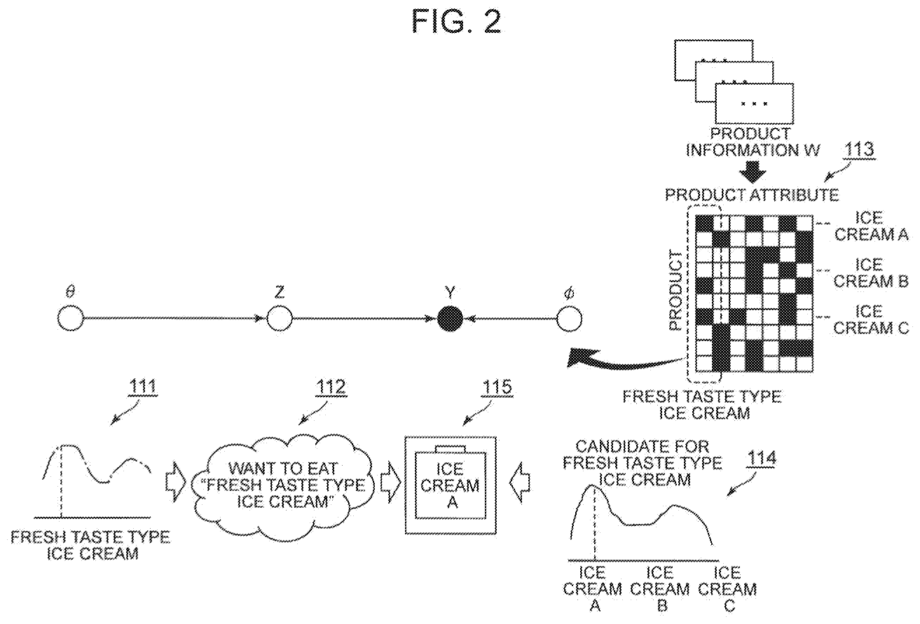

First exemplary embodiment. FIG. 1 is a block diagram illustrating a configuration example of a first exemplary embodiment of a product characteristic score estimation device according to the present invention. FIG. 2 is an explanatory diagram illustrating an example of a relationship between a preference and purchase of a user.

In the present exemplary embodiment, a behavior mechanism of the user is probabilistically modeled, and a probability distribution space for product selection is limited. In the following description, the purchase of a product (that is, a purchasing mechanism) is illustrated as a behavior mechanism corresponding to the preference of the user. However, the behavior corresponding to the preference of the user is not limited to the purchase, and includes, for example, referring to, searching for, or displaying one product from among many products.

A behavior probability (for example, a purchase probability) for a product can be probabilistically modeled as “probability of directionality of preference of user”×“probability of selecting specific product from among products matching directionality of preference”.

In the following description, the directionality of the preference of the user (hereinafter, simply referred to as the preference of the user.) is represented by θ, a situation (information) in which a specific product is selected is represented by Y, and a specific preference is represented by z. In the present exemplary embodiment, a situation in which the preference of the user and a product attribute indicating a characteristic of the product are associated in one-to-one correspondence is assumed. Such association is performed, and thus, the interpretability of the preference and the product attribute can be enhanced.

Specifically, the preference θ of the user is realized by a vector indicating a preference that is easily apparent at the time of purchase. For example, when there are three product attributes {sweet taste, fresh taste, mild}, the preference θ of the user is also expressed by a three-dimensional vector meaning {sweet taste, fresh taste, mild}. Thus, the preference θ of the user may be referred to as a preference distribution of the user.

When the preference of the individual user is θᵤ, θᵤ is handled as a parameter of a probability distribution, for example, and represents a degree of preference that the individual user has for the product attribute. For example, a case where three preferences are expressed as θᵤ, ={0.1, 0.2, 0.7} means that a probability that a preference 1 appears is 10%, a probability that a preference 2 appears is 20%, and a probability that a preference 3 appears is 70%.

In the present exemplary embodiment, a preference degree (referred to as a score.) between the products for the product attributes is represented by (D. That is, D can be said to be a parameter indicating which product is likely to be selected for a certain preference. D is expressed by a vector of a product number dimension for each product attribute.

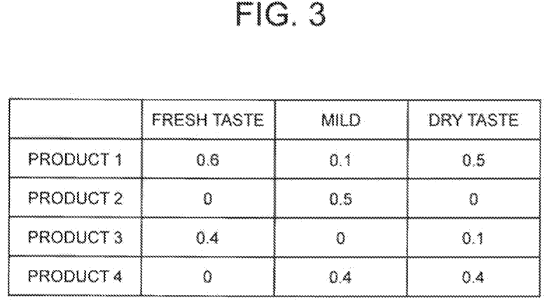

FIG. 3 is an explanatory diagram illustrating an example of the preference degree D between the products for the product attributes. FIG. 3 illustrates an example in which four-dimensional vectors {0.6, 0, 0.4, 0}, {0.1, 0.5, 0, 0.4}, and {0.5, 0, 0.1, 0.4} corresponding to four products are set for three types of product attributes {fresh taste}, {mild}, and {dry taste}.

For example, it is assumed that an attribute 2 ({mild}) appears as the preference of the user. Here, a case where Φ illustrated in FIG. 3 is set means that a product 1, a product 2, and a product 4 are listed as candidates, and probabilities of selecting the product 1, the product 2, and the product 4 are 10%, 50%, and 40%, respectively.

When the preference θ of the user, the specific preference z, and the preference degree (score) Φ between the products for the product attributes are used, a behavior probability P(Y) for the product is expressed by the following Equation 1.

$$\begin{matrix}[ Math . 1 ] & \\ P ( Y \vert θ , Φ ) = {\sum }_{x} P ( Y \vert Φ , z ) P ( z \vert θ ) & ( Equation 1 )\end{matrix}$$

In Equation 1, P(z|θ) indicates the probability of the directionality of the preference of the user, and P(Y|Φ, z) indicates the probability of selecting the specific product from among the products matching the directionality of the preference.

Referring to FIG. 2, the revealed preference (keyword) z is specified from the preference θ of the user. For example, it is assumed that the preference θ of the user for ice creams is expressed by a probability distribution 111 illustrated in FIG. 2. In the probability distribution 111, for example, there is a possibility that a preference having a highest probability (fresh taste type) is revealed as a preference 112 of the user.

On the other hand, when a preference degree 113 between the products for the product attributes is set based on product information W, a product 115 to be purchased is decided in accordance with a preference degree (score) distribution 114 among the products including the product attribute {fresh taste type} corresponding to the preference as a keyword. A matrix of the preference degree 113 illustrated in FIG. 2 means that a product attribute to which a black cell corresponds is included as an appeal point. The preference degree distribution 114 constitutes the probability distribution space for each preference based on the product including the preference as the keyword.

An object of the present exemplary embodiment is to estimate the preference θ of the user and the preference degree Φ between the products for the product attributes.

Referring to FIG. 1, a product characteristic score estimation device 100 according to the present exemplary embodiment includes a product attribute input unit 10, a training data input unit 20, an estimation unit 30, an output unit 40, and a storage unit 50.

The storage unit 50 stores various parameters used for processing by the estimation unit 30 to be described later. The storage unit 50 may store information received as an input by the product attribute input unit 10 or the training data input unit 20. The storage unit 50 is realized by, for example, a magnetic disk or the like.

The product attribute input unit 10 receives an input of the product attribute. The product attribute input unit 10 may directly receive the input of the attribute of each product, or may receive the product information including the product attribute. Examples of the product information include an explanatory sentence attached to the product. When the product information is received, the product attribute input unit 10 extracts a word related to the product attribute from the product information. Any method is used as a method for extracting the word related to the product attribute, and the product attribute input unit 10 may extract the word related to the product attribute from the product information by, for example, morphological analysis.

The training data input unit 20 inputs training data used for estimation of θ and Φ by the estimation unit 30 to be described later. The training data is data indicating a relationship between the user and the product, and specifically, is data indicating the product that is a target of the behavior in accordance with the preference of the user. For example, when attention is paid to a purchasing behavior as the behavior of the user, purchase data (purchase history) by the user may be used as the training data.

The estimation unit 30 estimates the preference θ of each user corresponding to the product attribute and the preference degree D of the user between the products for the product attributes based on the product attribute and the training data. Here, in the present exemplary embodiment, it is assumed that a behavior probability P(Y|θ, Φ) for the product based on training data Y is calculated by the product of the probability P(z|θ) and the probability (P(Y|Φ, z)) as indicated by Equation 1 described above. As described above, the probability P(z|θ) is a probability of the preference z of the user selected based on the preference distribution θ. P(Y|Φ, z) is a probability that the specific product is selected based on the preference z of the user selected by the probability P(z|θ) and the preference degree Φ between the products.

A plurality of methods is considered for calculating θ and Φ by using the training data. The estimation unit 30 may estimate θ and Φ that maximize the product of the behavior probabilities for all the pieces of training data Y based on θ and Φ by a method for maximizing a likelihood. In this case, for example, the estimation unit 30 may calculate θ and Φ that maximize the product of the probabilities for the product purchase information for all the users by using Equation 2 to be illustrated below.

$$\begin{matrix}[ Math . 2 ] & \\ L = {L}_{OR} ( {\prod }_{u , iP} P ( {Y}_{ut} \vert ϑ , Φ ) ) & ( Equation 2 )\end{matrix}$$

The estimation unit 30 may estimate θ and Φ when the training data Y is given by maximizing a posterior distribution. In this case, the estimation unit 30 may calculate θ and Φ that maximize the posterior distribution, for example, by using Equation 3 to be illustrated below. The prior distributions P(θ) and P(Φ) in Equation 3 may be set to arbitrary values in advance.

$$\begin{matrix}[ Math . 3 ] & \\ P ( ϑ , Φ \vert Y ) \times {\sum }_{x} P ( Y \vert Φ , z ) P ( z \vert θ ) P ( θ ) P ( Φ ) & ( Equation 3 )\end{matrix}$$

Here, since Φ is the preference degree between the products for the product attributes, the presence or absence of the product attribute regarding each product can be uniquely decided. For example, for a product attribute that does not correspond to a certain product, it is not necessary to set a degree for a preference indicating the product attribute. In other words, since only information as to whether or not a keyword is included for a certain product may be specified at an initial stage, it is not necessary to prepare Φ in which a value is set to the product attribute in advance. As described above, in the present exemplary embodiment, since it is not necessary to set an initial value for the preference degree, cost for estimating the preference degree can be reduced.

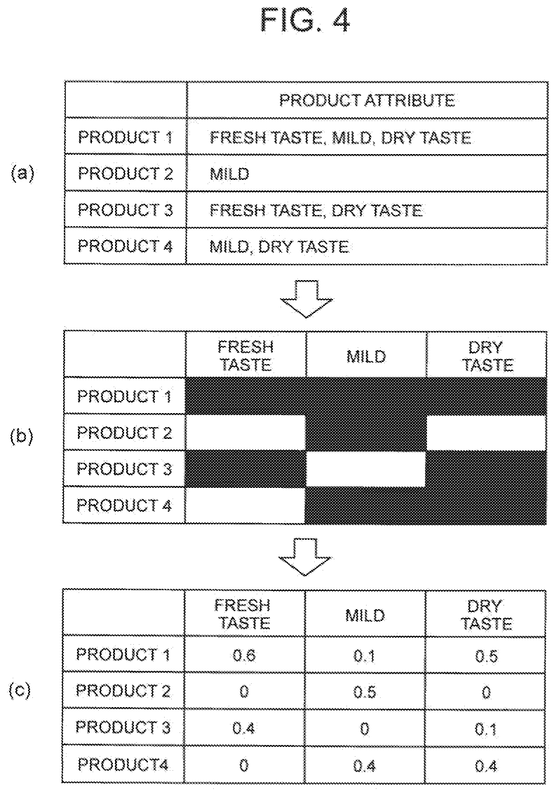

FIG. 4 is an explanatory diagram illustrating an example of processing of estimating a preference degree from a product attribute of a certain product. For example, three types of product attributes ({fresh taste}, {mild}, {dry taste}) are assumed for four products illustrated in FIG. 4 (see FIG. 4(a)). At this time, for example, for the product 1, all the product attributes are the appeal points, and for the product 2, only the product attribute {mild} is the appeal point. For the product 3, the product attributes {fresh taste} and {dry taste} are the appeal points, and for the product 4, the product attributes {mild} and {dry taste} are the appeal points.

Here, when the presence or absence of the product attribute is focused on, the product attribute to be considered for each product corresponds to a portion of a black cell illustrated in FIG. 4(b). Thus, the estimation unit 30 may calculate D by estimating the preference degree corresponding to the portion of the black cell. The example illustrated in FIG. 4(c) indicates that preference degrees other than 0 are set in portions corresponding to the black cells.

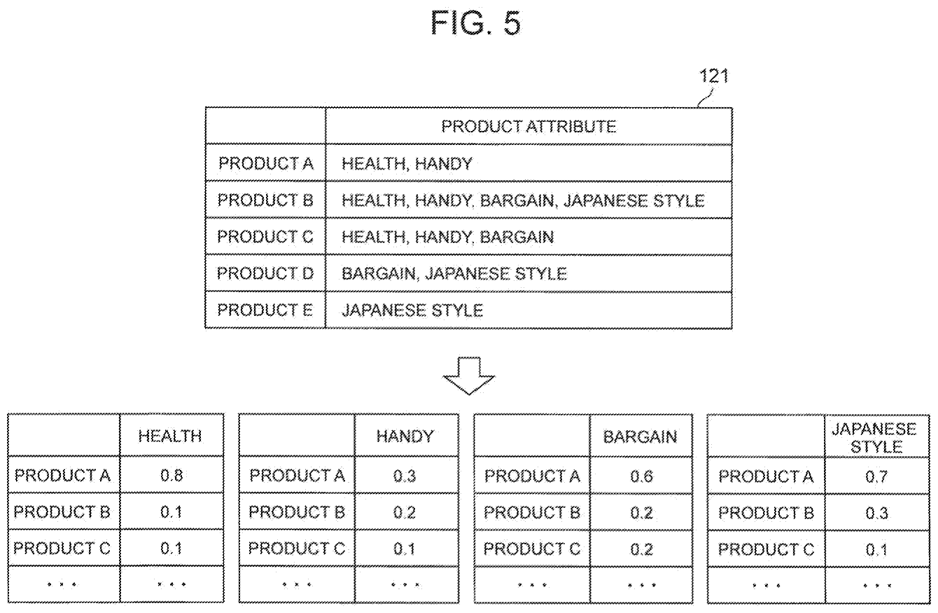

The output unit 40 outputs the preference degree between the products for the product attributes. FIG. 5 is an explanatory diagram illustrating an example of the output result. The example illustrated in FIG. 5 illustrates an example in which the output unit 40 outputs the preference degree of each product for each product attribute in descending order when there are appeal points (product attributes) 121 for products A to E. The output unit 40 may receive the product attribute designated by the user, and may output only the preference degree of the designated product attribute.

The product attribute input unit 10, the training data input unit 20, the estimation unit 30, and the output unit 40 are realized by a processor (for example, a central processing unit (CPU), a graphics processing unit (GPU), or a field-programmable gate array (FPGA)) of a computer that operates according to a program (product characteristic score estimation program).

For example, the program may be stored in the storage unit 50 included in the product characteristic score estimation device, and the processor may read the program and may operate as the product attribute input unit 10, the training data input unit 20, the estimation unit 30, and the output unit 40 according to the program. A function of the product characteristic score estimation device may be provided in a software as a service (SaaS) format.

Each of the product attribute input unit 10, the training data input unit 20, the estimation unit 30, and the output unit 40 may be realized by dedicated hardware. A part or all of the constituent components of each device may be realized by a general-purpose or dedicated circuitry, a processor, or a combination thereof. These constituent components may be realized by a single chip, or may be realized by a plurality of chips connected via a bus. A part or all of the constituent components of each device may be realized by a combination of the above-described circuitries and a program.

When a part or all of the constituent components of the product characteristic score estimation device are realized by a plurality of information processing devices, circuitries, and the like, the plurality of information processing devices, circuitries, and the like may be centrally arranged or may be distributedly arranged. For example, the information processing device, the circuitries, and the like may be realized as a form in which a client and server system, a cloud computing system, and the like are connected to each other via a communication network.

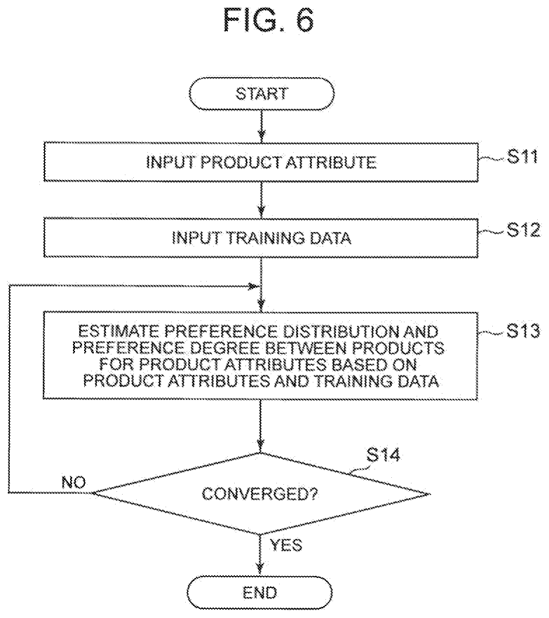

Next, an operation of the product characteristic score estimation device according to the present exemplary embodiment will be described. FIG. 6 is a flowchart illustrating an operation example of the product characteristic score estimation device according to the present exemplary embodiment. The product attribute input unit 10 inputs the product attribute (step S11). The training data input unit 20 inputs the training data (step S12). When the behavior probability is expressed by Equation 1 described above, the estimation unit 30 estimates the preference distribution θ and the preference degree Φ between the products for the product attributes based on the product attribute and the training data (step S13).

The estimation unit 30 performs convergence determination of estimation processing (step S14). For example, when the amount of change of a value to be maximized (or minimized), such as a posterior probability and a value of a likelihood function, falls below a predetermined value or ratio, the estimation unit 30 may determine that the processing has converged. When it is determined that the processing has converged (Yes in step S14), the estimation unit 30 ends the estimation processing. On the other hand, when it is not determined that the processing has converged (No in step S14), the estimation unit 30 repeats the tasks of processing in and after step S13.

As described above, in the present exemplary embodiment, when the behavior probability is expressed by Equation 1 described above and the training data input unit 20 inputs the training data, the estimation unit 30 estimates the preference distribution θ and the preference degree Φ between the products for the product attributes based on the product attribute and the training data. Thus, it is possible to estimate the preference degree between the products of the user for the characteristics of the products.

For example, behavior data, review data, or the like of the user present in an electronic commerce (EC) site, a moving image viewing site, a web migration log, or the like can be used as the training data of the present exemplary embodiment. It is possible to lead to marketing countermeasures such as promotion, product improvement, and new product development by quantifying an appeal point of a product assumed by a manufacturer and a gap of user evaluation by using such data.

An operator of an EC site or a product search site can use the preference degree between the products of the present exemplary embodiment in product listing by a keyword search.

### Second Exemplary Embodiment

Next, a second exemplary embodiment of the product characteristic score estimation device according to the present invention will be described. In the first exemplary embodiment, the estimation unit 30 estimates the preference degree of the product attribute received by the product attribute input unit 10. On the other hand, it may be difficult to appropriately prepare the product attributes to be considered for each product.

For example, it is possible to extract the appeal point of the product by, for example, morphological analysis or the like based on the product information given to each product. However, in this case, words having the same meaning may be extracted as different product attributes due to a difference in expression. For example, the product attributes {fresh taste} and {fresh}, {sweet taste} and {sweet}, and the like are considered as words having the same meaning, but are extracted as different product attributes due to a difference in expression.

In this case, for example, when {fresh taste} and {fresh} are handled as different product attributes, since a score of a product that is {fresh taste} and a score of a product that is {fresh} are calculated independently, there is a possibility that comparison becomes difficult. Thus, it is necessary to decide the product attribute by aggregating words having the same meaning extracted redundantly.

However, when aggregation is performed only by closeness of the meaning of the word, appropriate aggregation is not necessarily performed. For example, {sweet} and {sweet taste} are considered to be semantically close when words are focused on, but may indicate meanings that are not so close from the preceding and following contexts. For example, it can be said that “sweet scent perfume” and “sweet taste curry” indicate meanings not so close to each other.

Under such circumstances, when {sweet} and {sweet taste} are simply aggregated as the same product attribute {sweetness}, since a score in which sweetness related to curry and sweetness related to perfume are mixed is estimated, there is a possibility that interpretation becomes rather difficult.

Here, the purchase information as an example of the training data includes not only information on the product but also a purchaser group of the product. For example, when a group purchasing “sweet” perfume is compared with a group purchasing “sweet taste” curry, there is a possibility that these groups can be separated. Thus, an object of the present exemplary embodiment is to estimate the preference degree of the user based on a more appropriate product attribute by aggregating product attributes while simultaneously taking into consideration not only a relationship between words but also behavior information such as purchase.

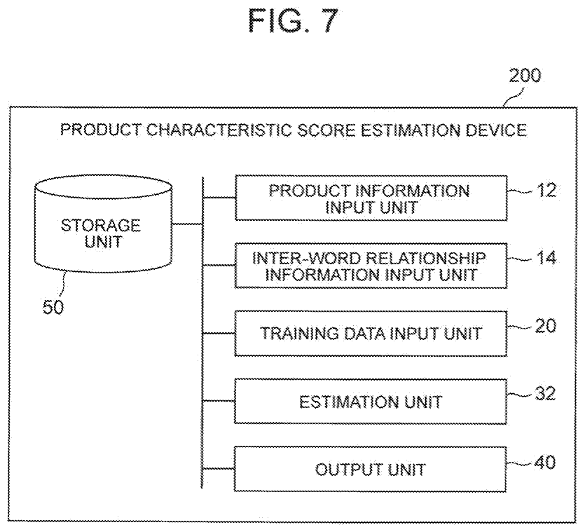

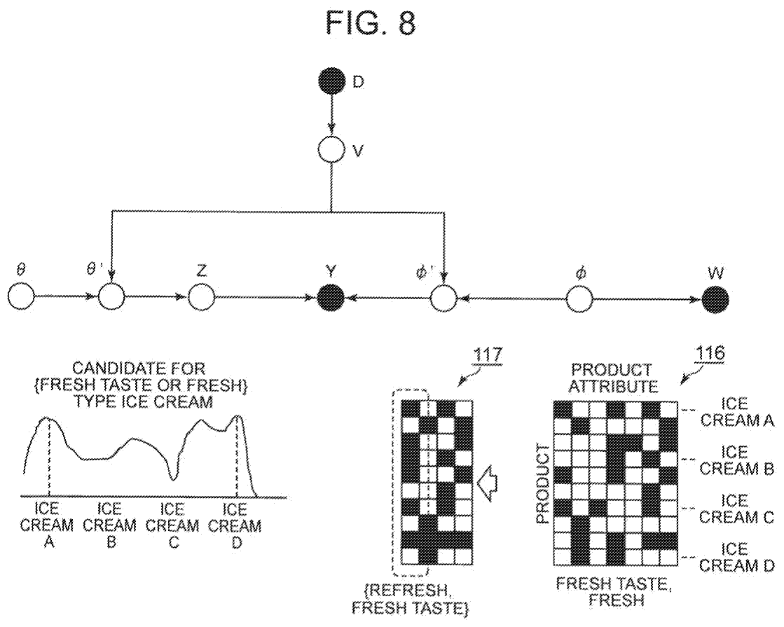

FIG. 7 is a block diagram illustrating a configuration example of the second exemplary embodiment of the product characteristic score estimation device according to the present invention. FIG. 8 is an explanatory diagram illustrating an example of a relationship between the preference and the purchase of the user and the closeness of the meaning between the words.

When the relationship example illustrated in FIG. 8 with the relationship example illustrated in FIG. 2, in the relationship example illustrated in FIG. 8, the product attributes are aggregated into one or more subsets v based on a closeness D of meaning between words representing the product attributes. As the closeness of meaning between words, for example, there is an inter-word distance by word embedding. The subset v is expressed as information in which product attributes are aggregated, such as v E {{refresh, fresh taste}, {sweet, sweetish}, {sweet taste}, {aroma, flavor}, . . . }.

Similarly to the first exemplary embodiment, in the present exemplary embodiment, a situation in which the preference of the user and the product attribute are associated in one-to-one correspondence is also assumed. In other words, for example, when the product attributes {sweet, sweet taste, fresh taste, mild} are prepared, the preferences {sweet, sweet taste, fresh taste, mild} are similarly prepared on the user preference side.

In such a situation, in the present exemplary embodiment, the preferences of the user are also aggregated in accordance with the product attributes. As illustrated in FIG. 8, a preference degree 116 (preference degree Φ) between products for product attributes extracted from the product information w is calculated as a preference degree 117 (preference degree Φ′) between products for an aggregated product attribute. The preference distribution θ of the user is also calculated as a preference distribution θ′ of the same dimension as the aggregated product attribute space.

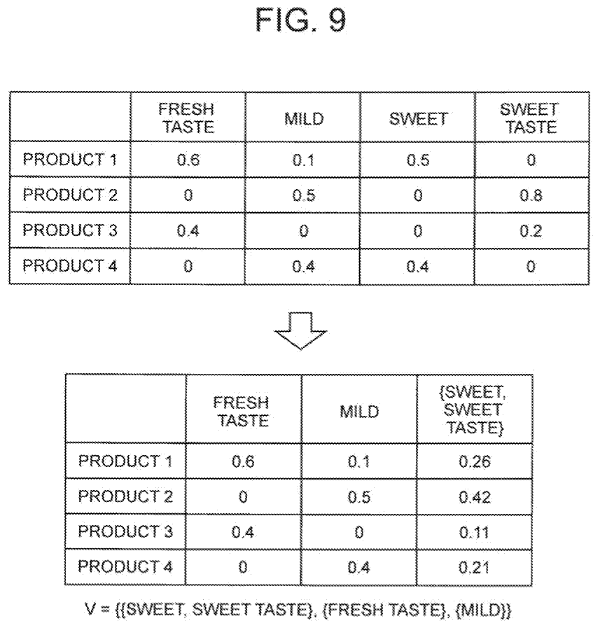

FIG. 9 is an explanatory diagram illustrating an example in which the product attributes and the preferences of the user are aggregated. As illustrated in FIG. 9, the product attribute and the preference of the user are aggregated based on a correspondence between the products and the product attributes and the subset v. For example, as illustrated in FIG. 9, it is assumed that the product attributes are aggregated into the subset v={{sweet, sweet taste}, {fresh taste}, {mild} }. That is, it is assumed that the product attributes {sweet} and {sweet taste} are aggregated. In this case, the scores of the aggregated attributes are also aggregated. In the example illustrated in FIG. 9, the score of the product attribute {sweet} and the score of the product attribute {sweet taste} are added, and normalization is performed such that the sum in product directions is 1.

Referring to FIG. 7, a product characteristic score estimation device 200 according to the present exemplary embodiment includes a product information input unit 12, an inter-word relationship information input unit 14, a training data input unit 20, an estimation unit 32, an output unit 40, and a storage unit 50. That is, the product characteristic score estimation device 200 according to the present exemplary embodiment is different from the product characteristic score estimation device 100 according to the first exemplary embodiment in that the product information input unit 12, the inter-word relationship information input unit 14, and the estimation unit 32 are provided instead of the product attribute input unit 10 and the estimation unit 30.

The product information input unit 12 inputs product information indicating a content of each product. Any content is used as the content of the product information, and for example, the explanatory sentence of the product and image data describing the explanatory sentence of the product described above are input. The product information input unit 12 extracts a word related to the product attribute from the product information, similarly to the product attribute input unit 10 in the first exemplary embodiment.

The inter-word relationship information input unit 14 inputs a relationship between words used when the words included in the product information are aggregated (hereinafter, referred to as inter-word relationship information.). For example, the inter-word relationship information input unit 14 inputs, as the inter-word relationship information, an embedding vector of each word. However, the inter-word relationship information is not limited to the embedding vector described above, and may be other information as long as the information includes a characteristic that can be used when the estimation unit 32 to be described later aggregates words.

For example, other examples of the inter-word relationship information include a category tree, a hierarchical structure of words according to a subordinate relationship or a superordinate relationship, and the like. The category tree is, for example, a hierarchical structure between words set on the EC site, and an example thereof includes a hierarchical structure such as “health relationship→medicine→cold medicine”.

Similarly to the estimation unit 30 according to the first exemplary embodiment, the estimation unit 32 estimates the preference θ of each user corresponding to the product attribute and the preference degree Φ of the user between the products for the product attributes based on the product attribute and the training data. In the present exemplary embodiment, the estimation unit 32 aggregates the product attributes into one or more subsets v based on the closeness D of meaning between the words indicating the product attributes from the input inter-word relationship information.

Any method is used as a method for deciding the subset v from the closeness D of meaning between the words. The estimation unit 32 may decide the subset v by using, for example, hierarchical clustering. The hierarchical clustering is a method for gradually enlarging clusters while aggregating words having close distances. Specifically, an operation of creating a larger cluster by searching for two clusters C 1 and C2 at the closest distance and combining the searched clusters C1 and C2 is repeated.

An inter-cluster distance d(C1, C2) is defined by words belonging to the cluster C1 and the cluster C2. For example, a minimum distance among the inter-word distances d(x1, x2) defined by a word x1 belonging to the cluster C1 and a word x2 belonging to the cluster C2 may be defined as d(C1, C2).

For example, when the embedding vector is prepared for each word by embedding words such as Word2Vec as the inter-word relationship information, the estimation unit 32 may decide the subset v by a k-means method by directly using this word vector.

The estimation unit 32 calculates the preference distribution θ′ of each user obtained by aggregating the product attributes of the preference distribution θ in accordance with the subset v, and further calculates Φ′ obtained by aggregating the product attributes at the preference degree Φ between the products in accordance with the subset v. The estimation unit 32 estimates the preference distribution θ of each user, the preference degree Φ between the products, and the subset v to be aggregated by using the preference distribution θ′ of each user in which the product attributes are aggregated and the preference degree Φ′ between the products in which the product attributes are aggregated.

For example, similarly to the first exemplary embodiment, the estimation unit 32 may estimate v, θ, and Φ that maximize the posterior distribution. Specifically, a probability model P(v|D) of the subset v generated by the closeness D of meaning between the words is defined, and the estimation unit 32 may calculate v, θ, and Φ that maximize the posterior distribution by using Equation 4 to be illustrated below. The prior distributions P(θ) and P(Φ) in Equation 4 may be set to arbitrary values in advance similarly to Equation 3.

$$\begin{matrix} [ Math . 4 ] & \\ P [ r , θ , Φ \vert Y ) = {\sum }_{x} {\sum }_{{θ}^{′}} {\sum }_{{Φ}^{′}} P ( Y \vert {Φ}^{′} , z ) P ( z \vert {θ}^{′} ) P ( {θ}^{′} \vert θ , v ) P ( {Φ}^{′} \vert Φ , v ) P ( v \vert D ) P ( θ ) P ( Φ ) & ( Equation 4 )\end{matrix}$$

Hereinafter, a method for realizing the probability model P(v|D) will be described. In the method for deciding the subset v from the closeness D of meaning between the words as described above, there is a possibility that the words changing depending on the preceding and subsequent contexts cannot be appropriately aggregated, but it is known that many words can be appropriately aggregated. Thus, it is preferable that the subset v of the product attributes decided based on the closeness of meaning between the words is close to the subset v of the product attributes estimated by optimization.

It is considered that P(v|D) is defined such that the number of clusters N₁ decided by the method for deciding the subset v from the closeness D of meaning between the words is close to the number of clusters N₂ of the aggregated subset v. The estimation unit 32 may estimate v, θ, and Φ that maximize the posterior discpmtribution by using P(v|D) defined as Equation 5 to be illustrated below. a in Equation 5 is a coefficient.

[Math. 5]

P(v|D)∝exp(−c(N₁−N₂)²) (Equation 5)

It is also considered that P(v|D) is defined such that data belonging to a cluster is close. When d(⋅) is a root mean square of the distances in the cluster, the estimation unit 32 may estimate v, θ, and Φ that maximize the posterior distribution by using P(v|D) defined as Equation 6 to be illustrated below. In Equation 6, a cluster Ck′ is a cluster decided by the method for deciding the subset v from the closeness D of meaning between the words, and a cluster Ck is a cluster of the aggregated subset v.

$$\begin{matrix}[ Math . 6 ] & \\ P ( v \vert D ) ∝ {\prod }_{k} exp ( - {a ( \dot{a} ( {C}_{k}^{t} ) - d ( {C}_{k} ) )}^{2} ) & ( Equation 6 )\end{matrix}$$

The product information input unit 12, the inter-word relationship information input unit 14, the training data input unit 20, the estimation unit 32, and the output unit 40 are realized by the processor of the computer that operates according to the program (product characteristic score estimation program).

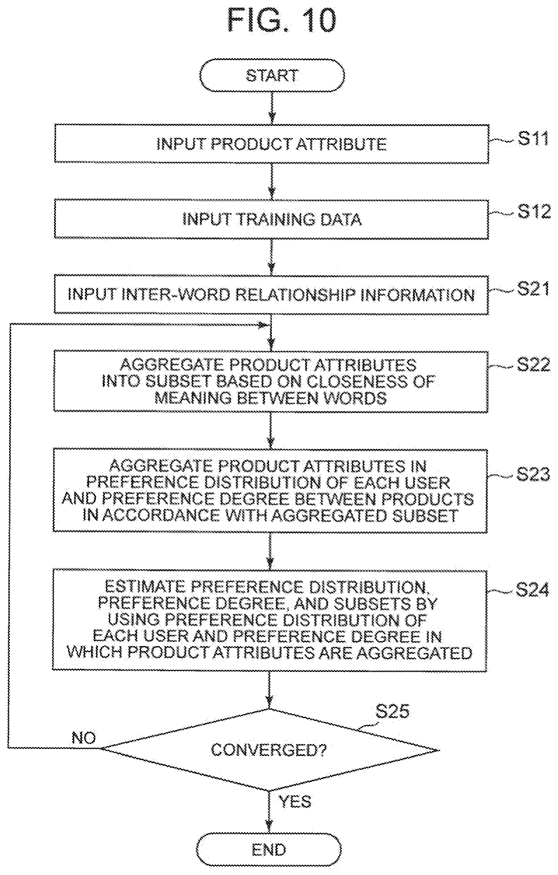

Next, an operation of the product characteristic score estimation device according to the present exemplary embodiment will be described. FIG. 10 is a flowchart illustrating an operation example of the product characteristic score estimation device according to the present exemplary embodiment. The tasks of processing from step S11 to step S12 for inputting the product attribute and the training data are similar to the tasks of processing illustrated in FIG. 6. In the present exemplary embodiment, the inter-word relationship information input unit 14 inputs the inter-word relationship information (step S21).

The estimation unit 32 aggregates the product attributes into one or more subsets based on the closeness of meaning between the words indicating the product attributes (step S22). The estimation unit 32 aggregates the product attributes in the preference distribution of each user and the preference degree between the products in accordance with the aggregated subset (step S23). The estimation unit 32 estimates the preference distribution of each user, the preference degree between the products, and the subset to be aggregated by using the preference distribution of each user and the preference degree between the products in which the product attributes are aggregated (step S24).

Thereafter, in step S25, the estimation unit 32 performs the convergence determination similarly to step S14 in FIG. 6. That is, when it is determined that the processing has converged (Yes in step S25), the estimation unit 32 ends the estimation processing. On the other hand, when it is not determined that the processing has converged (No in step S25), the estimation unit 32 repeats the tasks of processing in and after step S22.

As described above, in the present exemplary embodiment, the estimation unit 32 aggregates the product attributes into one or more subsets based on the closeness of meaning between the words indicating the product attributes, aggregates the product attributes in the preference distribution of each user and the preference degree between the products in accordance with the aggregated subsets, and estimates the preference distribution of each user, the preference degree between the products, and the subset to be aggregated by using the preference distribution of each user and the preference degree between the products in which the product attributes are aggregated.

Accordingly, in addition to the effects of the first exemplary embodiment, it is possible to calculate a more appropriate score in which redundant product attributes are aggregated.

### Third Exemplary Embodiment

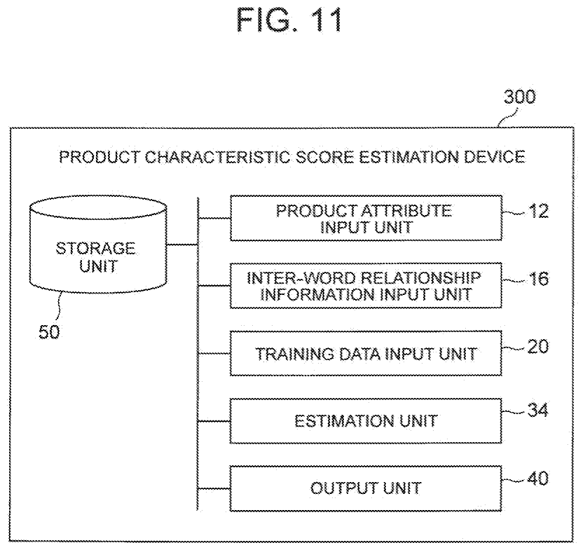

Next, a third exemplary embodiment of the product characteristic score estimation device according to the present invention will be described. In the first exemplary embodiment and the second exemplary embodiment, a situation in which the preference of the user and the product attribute are associated in one-to-one correspondence is assumed. In the present exemplary embodiment, an estimation method when the preference of the user and the product attribute are not in a one-to-one correspondence will be described. FIG. 11 is a block diagram illustrating a configuration example of the third exemplary embodiment of the product characteristic score estimation device according to the present invention.

In the present exemplary embodiment, when it is assumed that a word set U=(u₁, u₂, . . . , u_{L}) of the preferences of the user and a set I=(i₁, i₂, . . . , i_{M}) of the product attributes are associated by a relationship T, the preferences of the user and the product attributes are connected by performing conversion processing based on the relationship T between the preferences of the user and the product attributes. The relationship T is given in advance by the user or the like.

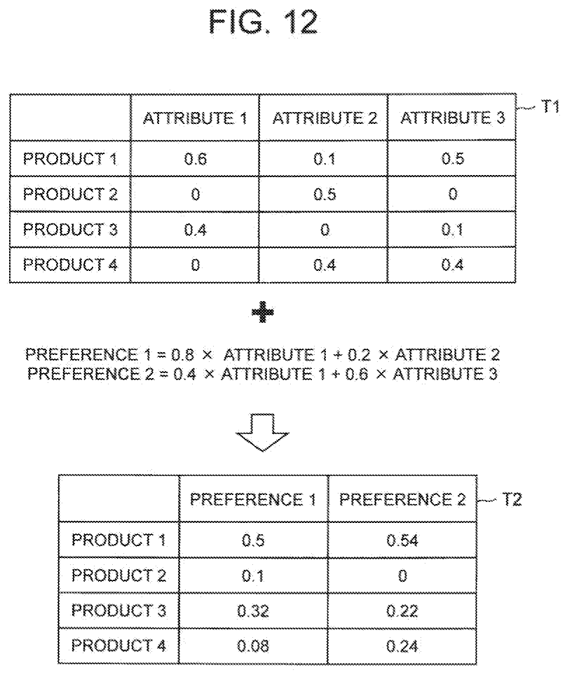

FIG. 12 is an explanatory diagram illustrating an example of the conversion processing based on the relationship T. It is assumed that the probabilities of selecting the attributes 1 to 3 for the products 1 to 4 are estimated as in Table T1 illustrated in FIG. 12. Here, it is assumed that the preferences and the attributes are converted by the relationship T such as preference 1=0.8×attribute 1+0.2×attribute 2 and preference 2=0.4×attribute 1+0.6×attribute 3.

In this case, when the preference 1 becomes apparent, the probability P(Y|Φ, T, z) of purchasing the product 1 can be defined as Equation 7 to be illustrated below.

[Math. 7]

P∝0.8×(attribute 1)+0.2×(attribute 2) (Equation 7)

In this case, the probabilities in Table T1 can be converted into probabilities illustrated in Table T2. Similarly to the example illustrated in FIG. 9, Table T2 is normalized such that the sum in the product directions is 1. When the relationship T is linear conversion described above, it can be defined as P (Yᵤᵢ|Φ, T, z)∝matrix Φ and a component in an i-th row and a z-th column in a product of transposition of T). The reason why such a definition can be made will be described later.

The behavior probability P(Y) when the relationship T is used is expressed by Equation 8 to be illustrated below in a generalized manner.

$$\begin{matrix}[ Math . 8 ] & \\ P ( {Y}^{′} \vert θ , Φ ) - {\sum }_{z} P ( Y \vert Φ , T , z ) P ( z \vert θ ) & ( Equation 8 )\end{matrix}$$

The reason why the behavior probability P(Y|θ, Φ) can be expressed by the above Equation 8 is as follows. In other words, for P(Y|Φ, T, z), when the preference of the user is an L dimension and the product attribute is an M dimension, T can be expressed by a matrix of L rows and M columns when T is linear conversion. On the other hand, the preference degree between the products (probability parameter of the product attribute) Φ can be expressed by a matrix of (rows of number of products)×(the number of aggregated product attributes, that is, M columns).

By a product of transposition of the matrices Φ and T, a matrix of (rows of number of products)×(number of aggregated preferences, that is, L columns) can be obtained. An i-th row and a j-th column of this matrix correspond to “probability of selecting product i corresponding to preference j”. Accordingly, under the conditions of Φ, T, and z, a probability of purchasing a product i can be calculated by a z component in the i-th row of the matrix for which appropriate normalization has been performed for the product of transposition of the matrices Φ and T.

In this case, a posterior probability is expressed by Equation 9 to be illustrated below.

$$\begin{matrix}[ Math . 9 ] & \\ P ( θ , Φ \vert Y ) ∝ {\sum }_{z} P ( Y \vert Φ , T , z ) P ( z \vert θ ) P ( θ ) P ( Φ ) & ( Equation 9 )\end{matrix}$$

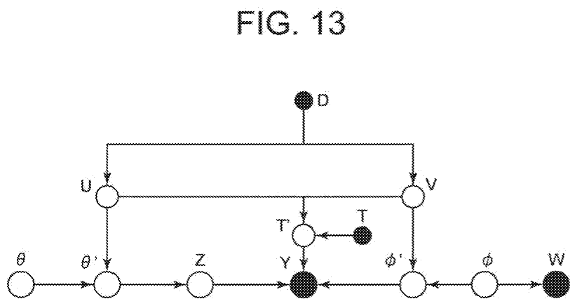

Similarly to the second exemplary embodiment, the product attributes may be aggregated. FIG. 13 is an explanatory diagram illustrating another relationship example between the preference and the purchase of the user and the closeness of meaning between the words. FIG. 13 illustrates an example in which when the preferences of the user and the product attributes are not in the same dimension (are not in the same name), the preferences of the user and the product attributes are independently aggregated by the closeness D of meaning between the words.

In the second exemplary embodiment, the product attributes are aggregated based on one piece of inter-word relationship information. In the present exemplary embodiment, the inter-word relationship information regarding the product attribute and the inter-word relationship information regarding the preference of the user are used. For example, {dry taste, fresh taste, mild} are assumed as the product attributes, and {outdoor, popular, latest} are assumed as the preferences of the user. In this case, three distances d(dry taste, fresh taste), d(fresh taste, mild), and d(mild, dry taste) between the product attributes are decided by using the inter-word relationship information regarding the product attribute. Three distances d(outdoor, popular), d(popular, latest), and d(latest, outdoor) between the preferences of the user are decided by using the inter-word relationship information regarding the preference of the user.

In the example illustrated in FIG. 13, U is a subset in which the preferences of the user are aggregated, and V is a subset in which the product attributes are aggregated. For example, in the example illustrated in FIG. 13, it is assumed that relationships between three preferences 1 to 3 and attributes are defined as preference 1=0.8×attribute 1+0.2×attribute 2, preference 2=0.4×attribute 1+0.6×attribute 3, and preference 3=0.1×attribute 2+0.9×attribute 3, respectively.

Here, it is assumed that the subset U and the subset V are aggregated as V={{attribute 1, attribute 2}, {attribute 3}} and U={{preference 1}, {[preference 2, preference 3}}, respectively. In this case, the relationship (conversion rule) T between the attribute and the preference can be converted into the following conversion rule V based on the aggregated contents of the subset (preference group) U and the subset (preference group) V.

{preference 1}=1.0×{attribute 1,attribute 2}

{preference 2,preference 3}=0.5×{attribute 1,attribute 2}+1.5×{attribute 3}

In the case of the linear conversion described above, when the relationship T is considered as a matrix, an operation of the relationship T corresponds to an operation on a column and a row.

Referring to FIG. 11, a product characteristic score estimation device 300 according to the present exemplary embodiment includes a product information input unit 12, an inter-word relationship information input unit 16, a training data input unit 20, an estimation unit 34, an output unit 40, and a storage unit 50. That is, the product characteristic score estimation device 300 according to the present exemplary embodiment is different from the product characteristic score estimation device 200 according to the second exemplary embodiment in that the inter-word relationship information input unit 16 and the estimation unit 34 are provided instead of the inter-word relationship information input unit 14 and the estimation unit 32.

The inter-word relationship information input unit 16 inputs the inter-word relationship information regarding the product attribute and the inter-word relationship information regarding the preference of the user. Similarly to the second exemplary embodiment, the inter-word relationship information input unit 16 may input, as the inter-word relationship information, a word distributed expression or an embedding vector of each word, for example. When the attributes are not aggregated, the product characteristic score estimation device 300 may not include the inter-word relationship information input unit 16.

Similarly to the estimation unit 32 according to the second exemplary embodiment, the estimation unit 34 estimates the preference θ of each user corresponding to the product attribute and the preference degree Φ between the products for the product attributes of the user based on the product attribute and the training data. The estimation unit 34 estimates the preference distribution based on the relationship T between the preference of the user and the product attribute.

Similarly to the first exemplary embodiment, the estimation unit 34 may estimate θ and Φ when the training data Y is given by maximizing the posterior distribution. In this case, the estimation unit 30 may calculate θ and Φ that maximize the posterior distribution, for example, by using Equation 8 described above based on the relationship T between the preference of the user and the product attribute.

The estimation unit 34 may aggregate the preferences of the user and the product attributes into one or more subsets U and V, respectively, from the input inter-word relationship information based on the closeness D of meaning between the words indicating the product attributes. The estimation unit 34 may calculate a relationship V obtained by converting the relationship T based on the aggregated contents of the subset U and the subset V.

In this case, the estimation unit 34 estimates the preference distribution θ of each user, the preference degree (score) Φ between the products, the subset U and the subset V to be aggregated by using the converted relationship T, the preference distribution θ′ of each user in which the product attributes are aggregated, and the preference degree Φ between the products in which the product attributes are aggregated.

For example, similarly to the second exemplary embodiment, the estimation unit 34 may estimate U, V, θ, and Φ that maximize the posterior distribution. Specifically, similarly to the second exemplary embodiment, a probability model P(V|D) of the subset V of the product attributes and a probability model P(U|D) of the subset U of the preferences of the user generated by the closeness D of meaning between the words are defined.

A probability model P(T′|T, U, V) of V selected by the subset U, the subset V, and the relationship T is defined. This probability model may be defined as, for example, a rule for converting T based on the aggregated contents of the subset U and the subset V as illustrated in FIG. 13. Specifically, when the arithmetic operation result (specifically, the conversion result from T to T′ based on U and V) based on the aggregated contents of the subset U and the subset V is T_, P(T′=T_|T, U, V)=1 and P(T′≠T_|T, U, V)=0 may be modeled. This means that conversion of T into a relationship other than T_ is not permitted.

Similarly to the probability model P(T′|T, U, V), a probability model P(θ′|θ, V) for the aggregated preference distribution θ′ selected based on the preference θ of the user and the subset V and a probability model P(θ′|θ, V) for the preference degree Φ between the products and the preference degree Φ′ between the aggregated products selected based on the subset V can also be defined as conversion rules as illustrated in FIG. 9.

Based on such a definition, the estimation unit 34 may calculate U, V, θ, and Φ that maximize the posterior distribution by using Equation 10 to be illustrated below. A method for realizing P(V|D) and P(U|D) in Equation 10 is similar to the method for realizing the probability model P(v|D) of the second exemplary embodiment.

$$\begin{matrix} [ Math . 10 ] & \\ P ( V , U , θ , Φ \vert Y ) = {\sum }_{z} {\sum }_{{θ}^{′}} {\sum }_{{Φ}^{′}} {\sum }_{{T}^{′}} P ( Y \vert {Φ}^{′} , z , {T}^{′} ) P ( z \vert {θ}^{′} ) P ( {θ}^{′} \vert θ , V ) P ( {Φ}^{′} \vert Φ , V ) P ( {T}^{′} \vert T , U , V ) P ( U \vert D ) P ( V \vert D ) P ( θ ) P ( Φ ) & ( Equation 10 )\end{matrix}$$

P(Y|Φ′, z, T) in Equation 10 is a probability that the preference z appears in the aggregated preference U and a product corresponding to the preference z is selected. The reason why such a probability can be calculated is as follows.

When the preferences of the user aggregated by the subset U are an L_{U} dimension and the product attributes aggregated by the subset V are an M_{V} dimension, V can be expressed by a matrix of L_{U} rows and M_{V} columns when V is linear conversion. On the other hand, the preference degree between the products (probability parameter of product attribute) Φ′ can be expressed by a matrix of (rows of number of product)×(number of aggregated product attributes, that is, M_{V} columns)

By a product of transposition of the matrices Φ′ and T′, a matrix of (rows of number of products)×(number of aggregated preferences, that is, L_{U} columns) can be obtained. An i-th row and a j-th column of this matrix correspond to “probability of selecting product i corresponding to preference j”. Accordingly, under the conditions of Φ′, z, and T, the probability of purchasing the product i can be calculated by the z component in the i-th row of the matrix for which appropriate normalization has been performed for the product of transposition of the matrices Φ′ and V.

The product information input unit 12, the inter-word relationship information input unit 16, the training data input unit 20, the estimation unit 34, and the output unit 40 are realized by the processor of the computer that operates according to the program (product characteristic score estimation program).

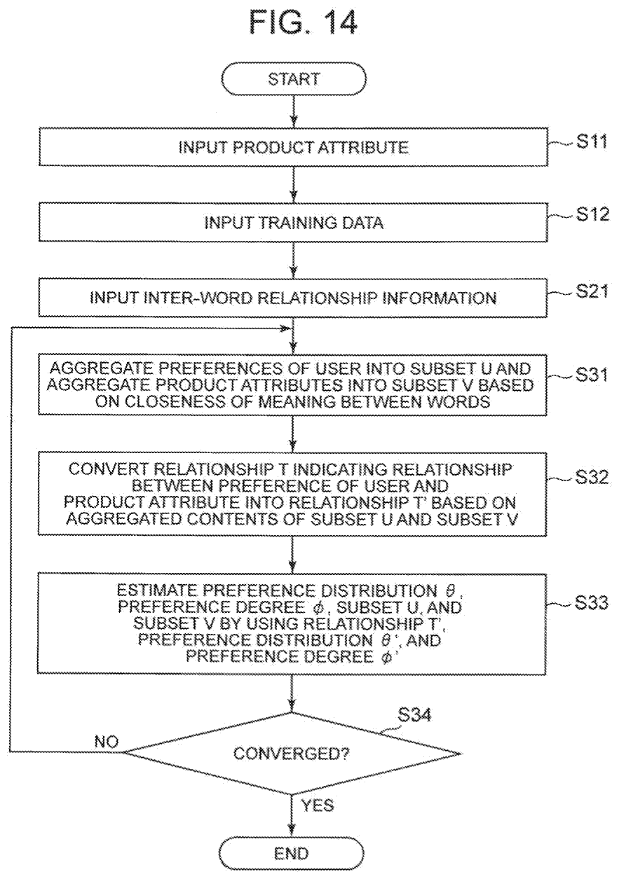

Next, an operation of the product characteristic score estimation device according to the present exemplary embodiment will be described. FIG. 14 is a flowchart illustrating an operation example of the product characteristic score estimation device according to the present exemplary embodiment. The flowchart illustrated in FIG. 14 illustrates an operation example when the aggregation is performed. The processing when the aggregation is not performed is similar to the processing illustrated in FIG. 6. The tasks of processing from step S11 to step S12 and the processing of step S21 for inputting the product attribute, the training data, and the inter-word relationship information are similar to the tasks of processing illustrated in FIG. 10.

The estimation unit 34 aggregates the preferences of the user into the first subset U and aggregates the product attributes into the second subset V based on the closeness of meaning between the words indicating the product attributes (step S31). Based on the aggregated contents of the first subset U and the second subset V, the estimation unit 34 converts the first relationship T indicating the relationship between the preference of the user and the product attribute into the second relationship V (step S32). The estimation unit 34 estimates the preference distribution θ of each user, the preference degree Φ between the products, the first subset U, and the second subset V by using the second relationship T′, the preference distribution θ′ of each user in which the product attributes are aggregated, and the preference degree Φ′ between the products in which the product attributes are aggregated (step S33).

Thereafter, in step S34, the estimation unit 34 performs the convergence determination similarly to step S14 in FIG. 6. That is, when it is determined that the processing has converged (Yes in step S34), the estimation unit 34 ends the estimation processing. On the other hand, when it is not determined that the processing has converged (No in step S34), the estimation unit 34 repeats the tasks of processing in and after step S33.

As described above, in the present exemplary embodiment, the estimation unit 34 aggregates the preferences of the user into the first subset U and aggregates the product attributes into the second subset V based on the closeness of meaning between the words indicating the product attributes. The estimation unit 34 converts the first relationship T indicating the relationship between the preference of the user and the product attribute into the second relationship T based on the aggregated contents of the first subset U and the second subset V. The estimation unit 34 estimates the preference distribution θ of each user, the preference degree Φ between the products, the first subset U, and the second subset V by using the second relationship T′, the preference distribution θ′ of each user in which the product attributes are aggregated, and the preference degree Φ′ between the products in which the product attributes are aggregated.

Accordingly, in addition to the effects of the first exemplary embodiment and the second exemplary embodiment, it is possible to calculate the score of the attribute specified in accordance with the preference of the user even when the preference and the product attribute do not correspond one-to-one.

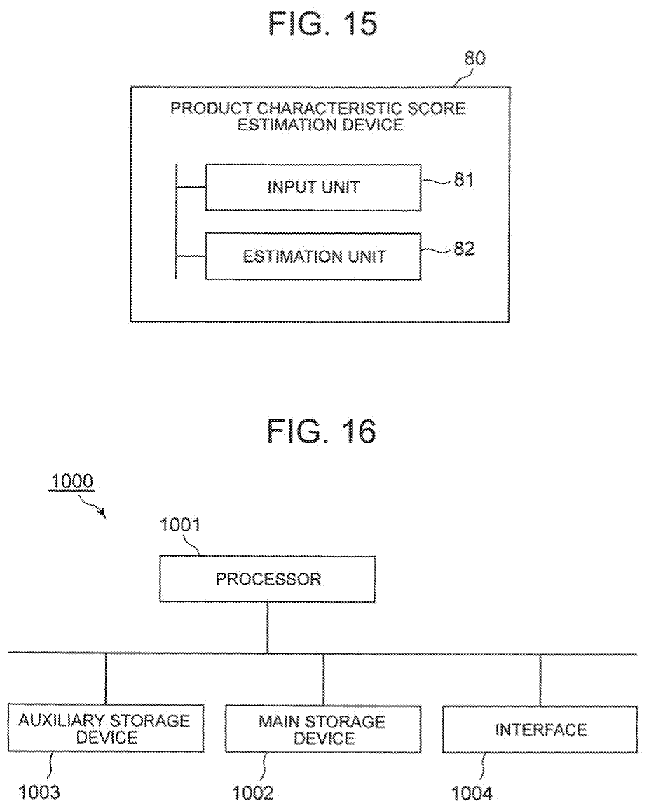

Next, an outline of the present invention will be described. FIG. 15 is a block diagram illustrating an outline of the product characteristic score estimation device according to the present invention. A product characteristic score estimation device 80 (for example, the product characteristic score estimation device 100) according to the present invention includes an input unit 81 (for example, the training data input unit 20) that inputs the training data (for example, purchase data) indicating the product that is the target of the behavior in accordance with the preference of the user, and an estimation unit 82 (for example, the estimation unit 30) that estimates the preference distribution (for example, θ) indicating the preference of each user corresponding to the product attribute and the preference degree (for example, Φ) of the user between the products for the product attributes based on the product attribute indicating the characteristic of the product and the training data.

When the behavior probability (for example, P(Y|θ, Φ) for the product based on the training data is calculated by the product of the probability (for example, P(40)) of the preference of the user selected based on the preference distribution and the probability (for example, P(Y|Φ, z)) of selecting the specific product based on the preference (for example, z) of the user selected by the probability and the preference degree (for example, Φ) between the products, the estimation unit 82 estimates the preference distribution (θ) and the preference degree (Φ) between the products by using the training data.

With such a configuration, it is possible to estimate the preference degree between the products of the user for the characteristics of the products.

Specifically, the estimation unit 82 may estimate the preference distribution that maximizes the product of the behavior probabilities for all the pieces of training data (for example, using Equation 2 described above) and the preference degree between the products for the product attributes.

The estimation unit 82 may estimate the preference distribution and the preference degree between the products for the product attributes when the training data is given (for example, using Equation 3 described above) by maximizing the posterior distribution.

The estimation unit 82 may aggregate the product attributes into one or more subsets (for example, v) based on the closeness of meaning (for example, D) between the words indicating the product attributes, may aggregate the product attributes into the preference distribution of each user in accordance with the aggregated subset, may aggregate the product attributes in the preference degree between the products in accordance with the aggregated subset, and may estimate the preference distribution (θ) of each user, the preference degree (Φ) between the products, and the subset (v) to be aggregated by using the preference distribution (for example, θ′) of each user in which the product attributes are aggregated and the preference degree (for example, Φ′) between the products in which the product attributes are aggregated.

At this time, the estimation unit 82 may estimate the preference distribution of each user, the preference degree between the products, and the subset to be aggregated so as to maximize the posterior distribution by using the probability model (for example, P(v|D)) of the subset generated by the closeness of meaning between the words.

The estimation unit 82 may estimate the preference distribution in which the product attribute and the preference of the user are associated in one-to-one correspondence (as described in the first exemplary embodiment and the second exemplary embodiment).

On the other hand, when the number of dimensions for the preference of the user is different from the number of dimensions for the product attribute (as illustrated in the third exemplary embodiment), the estimation unit 82 may estimate the preference distribution based on the relationship between the preference of the user and the product attribute.

At this time, the estimation unit 82 may aggregate the preferences of the user into the first subset (for example, U) and aggregate the product attributes into the second subset (for example, V) based on the closeness of meaning (for example, D′) between the words indicating the product attributes, may convert the first relationship (for example, the relationship T) indicating the relationship between the preference of the user and the product attribute into the second relationship (for example, the relationship T) based on the aggregate contents of the first subset and the second subset, and may estimate the preference distribution of each user, the preference degree between the products, the first subset, and the second subset by using the second relationship, the preference distribution of each user in which the product attributes are aggregated, and the preference degree between the products in which the product attributes are aggregated.

Moreover, the product characteristic score estimation device 80 may include an output unit (for example, the output unit 40) that outputs the preference degree between the products for the product attributes.

FIG. 16 is a schematic block diagram illustrating a configuration of the computer according to at least one exemplary embodiment. A computer 1000 includes a processor 1001, a main storage device 1002, an auxiliary storage device 1003, and an interface 1004.

The product characteristic score estimation device described above is implemented in the computer 1000. The operation of each processing unit described above is stored in the auxiliary storage device 1003 in the form of the program (product characteristic score estimation program). The processor 1001 reads out the program from the auxiliary storage device 1003, expands the program in the main storage device 1002, and executes the above processing according to the program.

In at least one exemplary embodiment, the auxiliary storage device 1003 is an example of a non-transitory tangible medium. As another example of the non-transitory tangible medium, there are a magnetic disk, a magneto-optical disk, a compact disc read-only memory (CD-ROM), a digital versatile disk read-only memory (DVD-ROM), a semiconductor memory, and the like connected via the interface 1004. When this program is distributed to the computer 1000 via a communication line, the computer 1000 to which the program is distributed may expand the program in the main storage device 1002 and may execute the above-described processing.

The program may be used for realizing a part of the functions described above. The program may be a so-called difference file (difference program) that realizes the above-described functions in combination with another program already stored in the auxiliary storage device 1003.

A part or all of the above-described exemplary embodiments can be described as, but not limited thereto, the following supplementary notes.

(Supplementary Note 1)

A product characteristic score estimation device including; an input unit that inputs pieces of training data indicating products as targets of a behavior in accordance with preferences of users; and an estimation unit that estimates a preference distribution indicating the preferences of each user corresponding to product attributes and a preference degree of the user between the products for the product attributes indicating characteristics of the products based on the product attributes and the training data, wherein the estimation unit estimates the preference distribution and the preference degree between the products by using the training data when a behavior probability for the product based on the training data is calculated by a product of a probability of the preference of the user selected based on the preference distribution and a probability of selecting a specific product based on the preference of the user selected with the probability and the preference degree between the products.

(Supplementary Note 2)

The product characteristic score estimation device according to supplementary note 1, wherein the estimation unit estimates a preference distribution and a preference degree between the products for the product attributes that maximize a product of behavior probabilities for all the pieces of training data.

(Supplementary Note 3)

The product characteristic score estimation device according to supplementary note 1, wherein the estimation unit estimates a preference distribution and a preference degree between the products for the product attributes when the training data is given by maximizing a posterior distribution.

(Supplementary Note 4)

The product characteristic score estimation device according to any one of supplementary notes 1 to 3, wherein the estimation unit aggregates the product attributes into one or more subsets based on closeness of meaning between words indicating the product attributes, aggregates the product attributes in the preference distribution of each user in accordance with the aggregated subset, aggregates the product attributes in the preference degree between the products in accordance with the aggregated subset, and estimates the preference distribution of each user, the preference degree between the products, and the subset to be aggregated by using the preference distribution of each user in which the product attributes are aggregated and the preference degree between the products in which the product attributes are aggregated.

(Supplementary Note 5)

The product characteristic score estimation device according to supplementary note 4, wherein the estimation unit estimates the preference distribution of each user, the preference degree between the products, and the subsets to be aggregated so as to maximize a posterior distribution by using a probability model of the subset generated by the closeness of meaning between the words.

(Supplementary Note 6)

The product characteristic score estimation device according to any one of supplementary notes 1 to 5, wherein the estimation unit estimates the preference distribution in which the product attributes and the preferences of the user are associated in one-to-one correspondence.

(Supplementary Note 7)

The product characteristic score estimation device according to any one of supplementary notes 1 to 5, wherein the estimation unit estimates the preference distribution based on a relationship between the preference of the user and the product attribute when the number of dimensions of the preference of the user is different from the number of dimensions of the product attribute.

(Supplementary Note 8)

The product characteristic score estimation device according to supplementary note 7, wherein the estimation unit aggregates the preferences of the user into a first subset and aggregates the product attributes into a second subset based on closeness of meaning between words indicating the product attributes, converts a first relationship indicating a relationship between the preference of the user and the product attribute into a second relationship based on the aggregated contents of the first subset and the second subset, and estimates the preference distribution of each user, the preference degree between the products, the first subset, and the second subset by using the second relationship, the preference distribution of each user in which the product attributes are aggregated, and the preference degree between the products in which the product attributes are aggregated.

(Supplementary Note 9)

The product characteristic score estimation device according to any one of supplementary notes 1 to 8, further including an output unit that outputs the preference degree between the products for the product attributes.

(Supplementary Note 10)

A product characteristic score estimation method including: inputting pieces of training data indicating products as targets of a behavior in accordance with preferences of users; and estimating a preference distribution indicating preferences of each user corresponding to product attributes and a preference degree of the user between the products for the product attributes indicating characteristics of the products based on the product attributes and the training data, wherein in the estimation, the preference distribution and the preference degree between the products are estimated by using the training data when a behavior probability for the product based on the training data is calculated by a product of a probability of the preference of the user selected based on the preference distribution and a probability of selecting a specific product based on the preference of the user selected with the probability and the preference degree between the products.

(Supplementary Note 11)

The product characteristic score estimation method according to supplementary note 10, further including: estimating a preference distribution and a preference degree between the products for the product attributes that maximize a product of behavior probabilities for all the pieces of training data.

(Supplementary Note 12)

The product characteristic score estimation method according to supplementary note 10, further including: estimating a preference distribution and a preference degree between the products for the product attributes when the training data is given by maximizing a posterior distribution.

(Supplementary Note 13)

A product characteristic score estimation program causing a computer to execute: input processing of inputting pieces of training data indicating products as targets of a behavior in accordance with preferences of users; and estimation processing of estimating a preference distribution indicating the preferences of each user corresponding to product attributes and a preference degree of the user between the products for the product attributes indicating characteristics of the products based on the product attributes and the training data, wherein, in the estimation processing, the preference distribution and the preference degree between the products are estimated by using the training data when a behavior probability for the product based on the training data is calculated by a product of a probability of the preference of the user selected based on the preference distribution and a probability of selecting a specific product based on the preference of the user selected with the probability and the preference degree between the products.

(Supplementary Note 14)

The product characteristic score estimation program according to supplementary note 13, wherein the product characteristic score estimation program causes the computer to further estimate a preference distribution and a preference degree between the products for the product attributes that maximize a product of behavior probabilities for all the pieces of training data in the estimation processing.

(Supplementary Note 15)

The product characteristic score estimation program according to supplementary note 13, wherein the product characteristic score estimation program causes the computer to further estimate a preference distribution and a preference degree between the products for the product attributes when the training data is given by maximizing a posterior distribution in the estimation processing.

### REFERENCE SIGNS LIST

10 Product attribute input unit
12 Product information input unit
14, 16 Inter-word relationship information input unit
20 Training data input unit
30, 32, 34 Estimation unit
40 Output unit
50 Storage unit
100, 200, 300 Product characteristic score estimation device

What is claimed is:

1. A product characteristic score estimation device comprising a hardware processor configured to execute a software code to:
input pieces of training data indicating products as targets of a behavior in accordance with preferences of users;
an estimation unit that estimates a preference distribution indicating the preferences of each user corresponding to product attributes and a preference degree of the user between the products for the product attributes indicating characteristics of the products based on the product attributes and the training data; and
estimate the preference distribution and the preference degree between the products by using the training data when a behavior probability for the product based on the training data is calculated by a product of a probability of the preference of the user selected based on the preference distribution and a probability of selecting a specific product based on the preference of the user selected with the probability and the preference degree between the products.

2. The product characteristic score estimation device according to claim 1, wherein the hardware processor is configured to execute a software code to
estimate a preference distribution and a preference degree between the products for the product attributes that maximize a product of behavior probabilities for all the pieces of training data.

3. The product characteristic score estimation device according to claim 1, wherein the hardware processor is configured to execute a software code to
estimate a preference distribution and a preference degree between the products for the product attributes when the training data is given by maximizing a posterior distribution.

4. The product characteristic score estimation device according to claim 1, wherein the hardware processor is configured to execute a software code to
aggregate the product attributes into one or more subsets based on closeness of meaning between words indicating the product attributes, aggregate the product attributes in the preference distribution of each user in accordance with the aggregated subset, aggregate the product attributes in the preference degree between the products in accordance with the aggregated subset, and estimate the preference distribution of each user, the preference degree between the products, and the subset to be aggregated by using the preference distribution of each user in which the product attributes are aggregated and the preference degree between the products in which the product attributes are aggregated.

5. The product characteristic score estimation device according to claim 4, wherein the hardware processor is configured to execute a software code to
estimate the preference distribution of each user, the preference degree between the products, and the subsets to be aggregated so as to maximize a posterior distribution by using a probability model of the subset generated by the closeness of meaning between the words.

6. The product characteristic score estimation device according to claim 1, wherein the hardware processor is configured to execute a software code to
estimate the preference distribution in which the product attributes and the preferences of the user are associated in one-to-one correspondence.

7. The product characteristic score estimation device according to claim 1, wherein the hardware processor is configured to execute a software code to
estimate the preference distribution based on a relationship between the preference of the user and the product attribute when the number of dimensions of the preference of the user is different from the number of dimensions of the product attribute.

8. The product characteristic score estimation device according to claim 7, wherein the hardware processor is configured to execute a software code to
aggregate the preferences of the user into a first subset and aggregate the product attributes into a second subset based on closeness of meaning between words indicating the product attributes, convert a first relationship indicating a relationship between the preference of the user and the product attribute into a second relationship based on the aggregated contents of the first subset and the second subset, and estimate the preference distribution of each user, the preference degree between the products, the first subset, and the second subset by using the second relationship, the preference distribution of each user in which the product attributes are aggregated, and the preference degree between the products in which the product attributes are aggregated.

9. The product characteristic score estimation device according to claim 1, wherein the hardware processor is configured to execute a software code to output the preference degree between the products for the product attributes.

10. A product characteristic score estimation method comprising:
inputting pieces of training data indicating products as targets of a behavior in accordance with preferences of users; and
estimating a preference distribution indicating preferences of each user corresponding to product attributes and a preference degree of the user between the products for the product attributes indicating characteristics of the products based on the product attributes and the training data,
wherein in the estimation, the preference distribution and the preference degree between the products are estimated by using the training data when a behavior probability for the product based on the training data is calculated by a product of a probability of the preference of the user selected based on the preference distribution and a probability of selecting a specific product based on the preference of the user selected with the probability and the preference degree between the products.

11. The product characteristic score estimation method according to claim 10, further comprising:
estimating a preference distribution and a preference degree between the products for the product attributes that maximize a product of behavior probabilities for all the pieces of training data.

12. The product characteristic score estimation method according to claim 10, further comprising:
estimating a preference distribution and a preference degree between the products for the product attributes when the training data is given by maximizing a posterior distribution.

13. A non-transitory computer readable information recording medium storing a product characteristic score estimation program, when executed by a processor, that performs a method for:
inputting pieces of training data indicating products as targets of a behavior in accordance with preferences of users; and
estimating a preference distribution indicating the preferences of each user corresponding to product attributes and a preference degree of the user between the products for the product attributes indicating characteristics of the products based on the product attributes and the training data,
wherein, the preference distribution and the preference degree between the products are estimated by using the training data when a behavior probability for the product based on the training data is calculated by a product of a probability of the preference of the user selected based on the preference distribution and a probability of selecting a specific product based on the preference of the user selected with the probability and the preference degree between the products.

14. The non-transitory computer readable information recording medium according to claim 13, further comprising:
estimating a preference distribution and a preference degree between the products for the product attributes that maximize a product of behavior probabilities for all the pieces of training data.

15. The non-transitory computer readable information recording medium according to claim 13, further comprising:
estimating a preference distribution and a preference degree between the products for the product attributes when the training data is given by maximizing a posterior distribution.
